(19) United States
(12) Patent Application Publication
(10) Pub. No.: US 2023/0325934 A1
(43) Pub. Date: Oct. 12, 2023

(54) METHOD AND SYSTEM OF IMAGE ANNOTATION AND ELEMENT EXTRACTION FOR AUTOMOBILE INSURANCE ANTI-FRAUD

(71) Applicant: ZHEJIANG LAB, Hangzhou (CN)

(72) Inventors: KAI DING, HANGZHOU (CN); CHONGNING NA, HANGZHOU (CN); JIAXI YANG, HANGZHOU (CN)

(21) Appl. No.: 18/133,515

(22) Filed: Apr. 11, 2023

(30) Foreign Application Priority Data
Apr. 12, 2022 (CN) 202210376689.2

(51) Int. Cl. G06Q 40/08; G06V 20/70; G06V 10/74

(52) U.S. Cl. CPC G06Q 40/08; G06V 20/70; G06V 10/761

(57) ABSTRACT

The present invention discloses a method and system of image annotation and element extraction for automobile insurance anti-fraud. The method of the present invention extracts anti-fraud elements from images such as automobile insurance scene collection and post supplementary images. The system of the present invention comprises an automobile insurance element table construction module, an image acquisition module, an annotation module and an element extraction module, wherein the annotation module comprises a multi-label classification annotation module, an automobile damage location annotation module and a personnel identity annotation module; and the element extraction module is used for performing element extraction on automobile insurance data. The present invention mainly focuses on image element annotation and extraction for automobile insurance anti-fraud, so that the extracted image elements are more objective, automobile insurance structured data which can be used for cross validation is generated, and the data quality is improved.

### FIELD OF TECHNOLOGY

The present invention belongs to the field of image processing technology, in particular to a method and system of image annotation and element extraction for automobile insurance anti-fraud.

### BACKGROUND TECHNOLOGY

At the same time, with the development of information technology in the financial and insurance industry, relevant business data is growing rapidly. How to use the rapidly growing data, especially more objective image data, to detect insurance fraud and effectively combat and deter anti-fraud activities have great significance for the automotive insurance industry. Most of the existing applications of intelligent identification technology in the automobile insurance industry are aimed at determining insurance losses. For example, the Chinese patent CN113344712A discloses an intelligent sorting and insurance compensation system based on image recognition, and the Chinese patent CN113706513A discloses an analysis method for automobile damage images based on image detection. Secondly, the existing image models mostly use public databases, with fewer types of extractable elements, and have little application value in anti-fraud. Thirdly, the annotation of automobile insurance image data is not targeted. Usually, only a small amount of automobile damage features are added when the pretrained model is fine-tuned, making the extracted results contain a large number of noise features, affecting the determination of the anti-fraud model.

### SUMMARY OF THE INVENTION

In view of the shortcomings of the prior art, the present invention proposes a method and system of image annotation and element extraction for automobile insurance anti-fraud.

To achieve the above technical objectives, the technical solution of the present invention is:

The first aspect of the embodiment of the present invention provides a method of image annotation and element extraction for automobile insurance anti-fraud, comprising the following steps:
S1. based on fraud type, extracting automobile insurance elements to construct an automobile insurance element table by setting a judgment basis;
S2. collecting an automobile accident scene image, and removing similar samples based on an image similarity measurement model through image vectorization and setting similarity threshold;
S3. based on the automobile insurance element table, annotating the automobile insurance features, automobile damage features, and personnel identity features respectively in the automobile accident scene images with similar samples removed, and obtaining the annotated datasets of the automobile insurance elements, automobile damage elements, and personnel identity elements; and
S4. extracting automobile insurance elements based on weighted multi-label for the automobile insurance element annotation dataset, extracting automobile damage elements based on target detection algorithms for the automobile damage element annotation dataset, and extracting the personnel identity information based on face detection algorithms for the personnel identity annotation dataset.

Preferably, the steps S1 is as follows: analyzing automobile insurance anti-fraud cases, summarizing the judgment basis for fraud types such as fake accident scene, repeated claims, fake personnel identity, and secondary collision, obtaining anti-fraud rules based on image elements, and constructing the automobile insurance element table; the automobile insurance elements comprises automobile damage area, automobile damage location, accident time, weather, accident type, automobile damage degree, and personnel identity information.

Preferably, the process of removing similar samples through image vectorization and setting similarity threshold of the steps S2 is as follows: using a fine-grained automobile classification database as a training set for the image similarity measurement model, the trained model is used as an image vectorization encoder; then, the distance between images is calculated using the image vectors and the farthest point sampling is performed, and the distance of the sample is maximized by setting the sampling number or image similarity threshold to meet the diversity of the sampled automobile accident scene images.

Preferably, the steps S3 is as follows: based on the automobile insurance element table, annotating the automobile insurance element including automobile number, driving status, accident type, both sides, weather, time, and road conditions, annotating the automobile damage element including dent, bump, bend, scratches, combustion, glass breakage, tire blowout, tear, and fall, and annotating personnel identity information, obtaining the automobile insurance element annotation dataset, the automobile damage element annotation dataset, and the personnel identity annotation dataset.

Preferably, the process of extracting automobile insurance elements based on weighted multi-label for the automobile insurance element annotation dataset is as follows: based on the Efficient net pretrained model based on Imagenet image dataset, the automobile insurance element annotation dataset is used as a training set to fine-tune the multi-label classification task based on weighted multi-label to obtain automobile insurance elements extracting model.

Preferably, the process of extracting automobile damage elements based on target detection algorithms for the automobile damage element annotation dataset is as follows: based on the Yolo pretrained model based on the COCO imagedataset, the automobile damage element annotation dataset is used as a training set, the multi-label classification task is finetuned on the automobile damage image training set to obtain the automobile damage elements extracting model, then the actual automobile damage area is calculated by standardizing the automobile damage pixel area.

Preferably, the process of standardizing the automobile damage pixel area is as follows: decoupling the correlation between the number of pixels surrounding the automobile damage with the camera angle and the distance between the camera and the vehicle, using the wheel as the side photo reference and the license plate as the front photo reference, calculating the ratio between the total pixels of the bounding-box and the actual size per pixel obtain a normalized automobile damage area; according to the actual size of the wheel and license plate, calculating the actual area per pixel.

The second aspect of the embodiment of the present invention provides a method of image annotation and element extraction for automobile insurance anti-fraud, comprising an automobile insurance element table construction module, an image acquisition module, an annotation module and an element extraction module;

the automobile insurance element table construction module, based on fraud type, extracting automobile insurance elements to construct an automobile insurance element table by setting a judgment basis;

the image acquisition module, collecting images to be annotated, the images are derived from automobile accident scene images collected by insurance companies, automobile damage image sets published online, and images collected through road monitoring cameras; the collected images also need to undergo previous preprocessing including deduplication and desimilarity;

the annotation module, annotating the automobile insurance features, automobile damage features, and personnel identity features in the images to be annotated, and obtaining an automobile insurance element annotation dataset, an automobile damage element annotation dataset, and a personnel identity annotation dataset;

the element extraction module, extracting elements from the automobile insurance element annotation dataset, the automobile damage element annotation dataset, and the personnel identity annotation dataset.

The third aspect of the embodiment of the present invention provides an electronic device, comprising a memory and a processor, the memory is coupled to the processor; the memory is used to store program data, and the processor is used to execute the program data to implement the method of image annotation and element extraction for automobile insurance anti-fraud.

The fourth aspect of the embodiment of the present invention provides computer-readable storage medium on which a computer program is stored, the program is executed by a processor to implement the method of image annotation and element extraction for automobile insurance anti-fraud.

The beneficial effect of the present invention is that the method of the present invention has many types of elements and has great application value in anti-fraud. Then, automobile insurance image data annotation is targeted, information such as weather, road conditions, automobile damage locations, and personnel identity information in automobile insurance cases. When fine-tuning the pretrained model, additional automobile damage features are added to reduce the impact of noise in the extracted result, laying a foundation for subsequent anti-fraud judgment.

### BRIEF DESCRIPTION OF THE DRAWINGS

FIG. 1 is a system framework diagram of the present invention;

FIG. 2 is a flowchart of the method of the present invention;

FIG. 3 is an example diagram of automobile insurance element annotation;

FIG. 4 is a first example diagram of automobile component and automobile damage annotation;

FIG. 5 is a second example diagram of automobile component and automobile damage annotation;

FIG. 6 shows a structural diagram of a computer device provided by an embodiment of the present invention.

### DETAILED DESCRIPTION OF THE EMBODIMENTS

An exemplary embodiment will be described in detail here, and an example thereof is shown in the drawings. When the following description refers to the drawings, unless otherwise indicated, the same numbers in different drawings represent the same or similar elements. The embodiments described in the following exemplary embodiments do not represent all embodiments consistent with the present invention. On the contrary, they are only examples of devices and methods consistent with some aspects of the present invention as detailed in the appended claims.

The terminology used in the present invention is for the purpose of describing specific embodiments only, and is not intended to limit the invention. The singular forms of “a”, “the”, and “the” used in the present invention and the appended claims are also intended to include most forms, unless the context clearly indicates otherwise. It should also be understood that the term “and/or” as used herein refers to and includes any or all possible combinations of one or more associated listed items.

It should be understood that although the terms first, second, third, etc. may be used in the present invention to describe various types of information, such information should not be limited to these terms. These terms are only used to distinguish the same type of information from each other. For example, without departing from the scope of the present invention, the first information may also be referred to as second information, and similarly, the second information may also be referred to as first information. Depending on the context, the word “if” as used herein can be interpreted as “when” or “when” or “in response to determination”.

The following is a detailed description of a method and system of image annotation and element extraction for automobile insurance anti-fraud proposed by the present invention in conjunction with the accompanying drawings. Without conflict, the features of the following embodiments can be combined with each other.

The present invention discloses a method and system of image annotation and element extraction for automobile insurance anti-fraud, extracting anti-fraud elements from images such as automobile accident scene images and post supplementary images. The system of the present invention comprises an automobile insurance element table construction module, an image acquisition module, an annotation module and an element extraction module.

The automobile insurance element table construction module, based on fraud type, extracting automobile insurance elements to construct an automobile insurance element table by setting a judgment basis.

The image acquisition module, collecting images to be annotated, the images are derived from automobile accident scene images collected by insurance companies, automobile damage image sets published online, and images collected through road monitoring cameras; the collected images also need to undergo previous preprocessing including deduplication and desimilarity.

The annotation module, annotating the automobile insurance features, automobile damage features, and personnel identity features respectively in the images to be annotated, comprising a multi-label classification annotation module, an automobile damage location annotation module and a personnel identity annotation module. The multi-label classification annotation module is used to annotate the automobile insurance elements such as weather, time, and road conditions in the image to be annotated to obtain an automobile insurance element annotation dataset. The automobile damage location annotation module is used to annotate the automobile damage location in the image to be annotated to obtain an automobile damage element annotation dataset. The personnel annotation module is used to annotate the personnel identity in the image to be annotated to obtain a personnel identity annotation dataset.

The element extraction module is used to extract elements from each annotation dataset to obtain the structured data, and adding the structured data to an anti-fraud system of an automobile insurance company, laying a foundation for subsequent cross validation and anti-fraud prediction. The element extraction module includes a multi-label classification model, an automobile damage element detection model, and a personnel recognition model. The multi-label classification model is used to extract automobile insurance elements from the automobile insurance element annotation dataset. The automobile damage element detection model is used to extract automobile damage elements from the automobile damage element annotation dataset. The personnel recognition model is used to extract personnel identity information from the personnel identity annotation dataset.

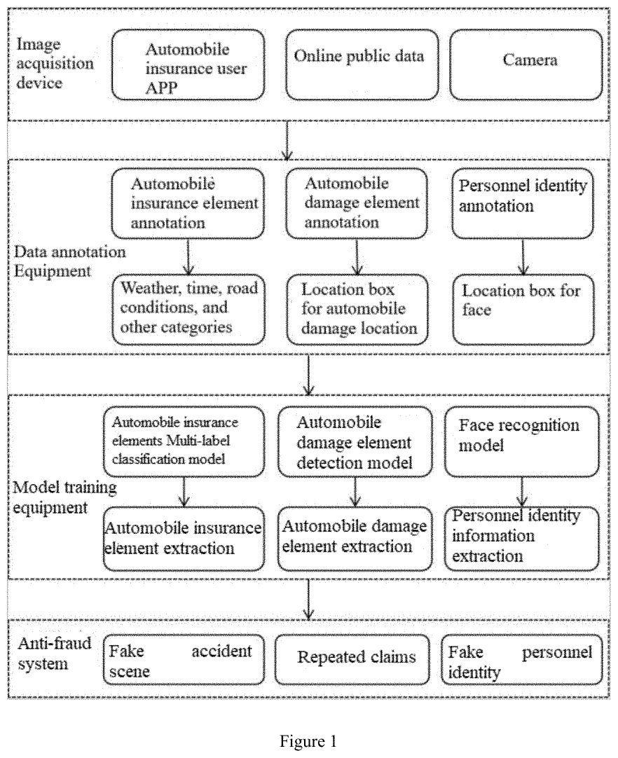

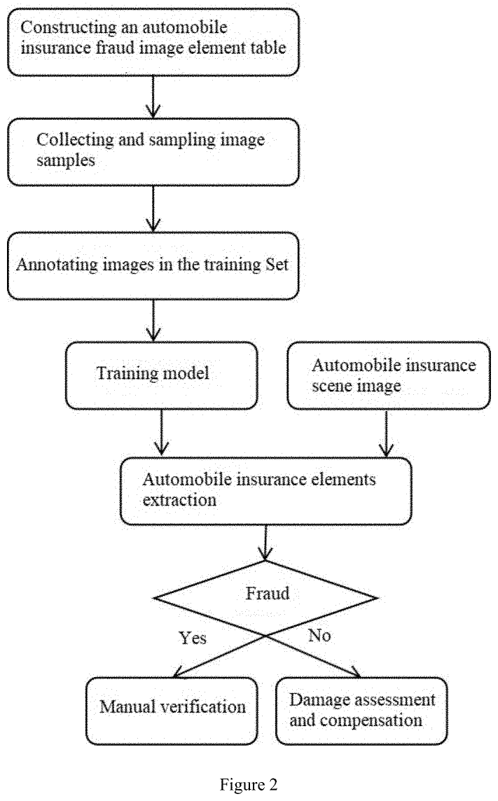

As shown in FIG. 1 to FIG. 2, the present invention focuses on solving fraud related to automobile insurance scene forgery, adopting a method of image annotation and element extraction for automobile insurance anti-fraud, constructing the complete automobile insurance image extraction element table and corresponding annotation and extraction method for the automobile insurance images. The specific steps are as follows:

S1. based on fraud type, extracting automobile insurance elements to construct an automobile insurance element table by setting a judgment basis, supplementing the lack of structured automobile insurance data to enhance the objectivity of the data.

Specifically, automobile insurance reporting data is mainly the structured data, while unstructured data includes text data such as case descriptions and image data such as the automobile accident scene images. The structured data of automobile insurance may have problems such as missing data, errors, and conflicting opinions due to the negligence and stance of operators. Therefore, using the automobile accident scene images and extracting relevant features can supplement the missing data and enhance the objectivity of the data.

First of all, by analyzing the forgery cases at the automobile insurance scene, a relatively complete extraction element table is purposefully constructed, as shown in Table 1. It can enhance the value of image element extraction function, supplement missing information, and reduce ambiguous data. Secondly, by proposing a set of annotation rules, the standardization of image element annotation can be improved, and the annotation efficiency can be improved. Proposing an extraction model that optimizes the amount of computation for annotation data, the overall cost of the system can be reduced.

TABLE 1
The extraction element table

| Fraud type | Judgment basis | extraction elements |
|---|---|---|
| fake | inconsistent damage degree, image | automobile damage area, automobile |
| accident | time, weather, and road type | damage location, accident time, weather, |
| scene | | automobile number, accident type, |
| | | accident parties |
| repeated | automobile duplication, automobile | license plate, automobile damage |
| claims | damage location duplication | location, automobile damage degree, |
| | | automobile damage area |
| fake | driver and insurance applicant not | Human face, personnel identity |
| personnel | identical; surveyor in the car accident | information |
| identity | scene not identical to his registered | |
| | face image | |
| secondary | inconsistent damage degree and | automobile damage area, automobile |
| collision | automobile damage location | damage location, automobile accident, |
| | duplication | accident parties, component, automobile |
| | | damage type |

According to the analysis of automobile insurance anti-fraud cases, the fraud can be divided into several types: fake accident scene, secondary collision, false reporting of theft and robbery, repeated claims, fake personnel identity, and intentional total loss, etc. Among them, the false reporting of theft and robbery may involve criminal liability and is difficult to confirm through images. The main means of intentional total loss is to use second-hand luxury automobiles for intentional damage and high-priced claims, currently, the response is to conduct a reasonable valuation for the insured automobile, reducing the difference between the total loss compensation amount and the actual price of the automobile, making intentional total loss unprofitable. In addition to the above two types, several other types of fraud can be judged using information extracted from images. The embodiment of the present invention summarizes the corresponding judgment basis for these fraud types and constructs the elements to be extracted, as shown in Table 1. Among them, both the fake accident scene and the secondary collision belong to the late forgery of past automobile damage, there are usually verifiable clues at the forgery scene, such as a forgery of a collision between two automobiles, due to the fact that the damage location and damage degree of the two automobiles are consistent, the height difference between the two automobile damage locations from the ground is significant, and the probability of a significant difference in the damage degree of the two automobiles is very small. In addition, the time and location of the forgery scene are also regular, areas with high morning and evening peaks and large traffic flow have high counterfeiting difficulty and cost. The repeated claims refer to multiple claims for the same accident, which can be judged by the repeatability of automobile license plate numbers and automobile damage locations. The fake personnel identity exists in accidents such as alcohol driving, and fraudsters use driver exchange to achieve compensation, the fraudulent behavior can be detected through face verification methods. The above features are important elements for judging whether a fraud occurs. The embodiment of the present invention performs image annotation and model training of automobile insurance elements based on this table.

S2. collecting an automobile accident scene image, and removing similar samples based on an image similarity measurement model through image vectorization and setting similarity threshold.

Collecting images to be annotated through the image acquisition module, the images are derived from automobile accident scene images collected by insurance companies, automobile damage image sets published online, and images collected through road monitoring cameras; the collected images also need to undergo previous preprocessing including deduplication and desimilarity;

The specific pretreatment methods of the deduplication and desimilarity is: using a fine-grained automobile classification database as a training set for the image similarity measurement model, the trained model is used as an image vectorization encoder; then, a farthest point sampling is calculated using a vectorized distance, and the distance of the sample is maximized by setting the sampling number or image similarity threshold to meet the requirements of subsequent element extraction model for sample diversity.

S3. based on the automobile insurance element table, annotating the automobile insurance features, automobile damage features, and personnel identity features respectively in the automobile accident scene images with similar samples removed, and obtaining the annotated datasets of the automobile insurance elements, automobile damage elements, and personnel identity elements.

The information such as the automobile insurance features, automobile damage features, and personnel identity features in the image to be annotated is annotated through the annotation module, including multi-label classification model, an automobile damage element detection model, and a personnel recognition model. The multi-label classification model is used to annotate automobile insurance elements such as weather, time, and road condition in the image to be annotated. The automobile damage location annotation module is used to annotate the automobile damage location in the image to be annotated, and mark the location box on the automobile damage location. The personnel annotation module is used to annotate the personnel identity in the image to be annotated and mark the position box on the face.

Specifically, the process of automobile insurance elements annotation is as follows: subsequent automobile insurance element extraction tasks are considered multi-label extraction tasks, so classification labels are used for annotating. In the embodiment of the present invention, a labelme tool is used for annotating, which traverses folders to read and display images, selects classification labels, and stores the annotation results as a txt file with the same file name as the corresponding image. An example of automobile insurance elements is shown in Table 2 below.

TABLE 2
Example Table of Automobile Insurance Elements

| Automobile | Running | Accident | Both | | | Road |
|---|---|---|---|---|---|---|
| number | state | type | sides | Weather | Time | conditions |
| Double | Parking | Injured | Car/car | Sunny | Day | Parking lot |
| automobile | status | | | | | |
| accident | | | | | | |
| Single | Parking | Injured | Car/falling | Overcast | Night | Community |
| automobile | status | | object | | | |
| accident | | | | | | |

Specifically, the process of automobile damage element annotation is as follows: the automobile damage element extraction task is considered as a target detection task, and the target object frame is used for annotating. In the embodiment of the present invention, the labelme tool is also used for annotating, which traverses folders, reads and displays images, manually selects the automobile component location and automobile damage location, and selects the component name and automobile damage type, as shown in the following table. The annotation result is stored as a txt or json file with the same file name as the corresponding image. An example of automobile damage elements is shown in Table 3 below.

TABLE 3
Example Table of Automobile Damage Elements

| Automobile | | |
|---|---|---|
| Damage | | |
| Area | Automobile Component Location | Automobile Damage Type |
| Continuous | Front, rear, left, right, lights, covers, | Dent, bump, bend, scratches, |
| values | bumpers, wheels, windshields, doors, | combustion, glass breakage, tire |
| | door glasses, crown | blowout, tear, and fall |

Specifically, the process of personnel element annotation includes: extracting personnel identity information and conducting consistency checks for driver theft and forgery by investigators in automobile insurance fraud. First, annotating the personnel identity information on the automobile insurance images. The personnel include drivers and surveyors from both sides of the accident, mainly extracting personnel identity information to facilitate the anti-raud system's consistency judgment against images stored in the database. The personnel identity information extraction task is regarded as a target detection task and annotated using the target object box. The labelme tool is used for annotating, where you only need to select a face in a box. The annotation result is stored as a txt or json file with the same file name as the corresponding image.

S4. extracting automobile insurance elements based on weighted multi-label for the automobile insurance element annotation dataset.

The process of automobile insurance element extraction for images specifically includes: multi-label classification for automobile insurance images, which mainly refers to extracting multiple accident elements from text, such as the accident automobile number, accident type, types of both parties to the accident, weather, traffic conditions, and so on. Generally, the extraction of each element of the automobile insurance image is considered as a task. In the embodiment of the present invention, it is proposed to use a multi-label classifier to complete the element extraction task.

The embodiment of the present invention is based on the Efficient net pretrained model based on the Imagenet image dataset, and performs fine tuning of multi-label classification tasks on the automobile insurance image training library. Firstly, the automobile accident image is taken as an input, and the Efficient net pretrained model is used as feature extraction and encoder. The Efficient pretrained model uses an Imagenet database containing thousands of types of images as a training set, ensuring its applicability to automobile insurance images. Next, the full connection layer of the original model is replaced with random weights to form a new classifier output layer. Then, the labeled multi-label are converted into one hot format as reference labels, and the classifier is trained using the binary cross entropy as a penalty function. The binary cross entropy function is as follows:

$$Loss \_bce = \{ \begin{matrix}- log ( \hat{y} ) , y = 1 \\ - log ( 1 - \hat{y} ) , y = 0\end{matrix}$$

where, Loss_bce is the binary cross entropy, ŷ is probability of a prediction of 1.

The above model is a basic multi-label model, when using the above model to train and predict automobile insurance multi-label data models, there is a lack of labels. For example, there should have been 4 labels, but the prediction result only had 3 labels. The main reason is that the sample distribution of some fields is uneven, and categories with few samples are difficult to learn. For this reason, the present invention uses a weighting method to improve the learning rate of these sparse and difficult samples. The multi-label penalty function is a binary class cross entropy, weighted as follows:

$$Loss = \{ \begin{matrix}- {{a}_{k} ( 1 - \hat{y} )}^{r} log \hat{y} , y = 1 \\ - {\hat{y}}^{r} log ( 1 - \hat{y} ) , y = 0\end{matrix}$$

Compared with the original binary cross entropy, the new penalty function adds aₖ and power function term. Where, ŷ is the probability that the prediction of 1, and aₖ is the weighted term of the positive and negative samples in the k-th field, defined as the ratio of the negative sample number to the positive sample number; the power function term weights indistinguishable samples, with r usually taken as 2, the easier the sample is to distinguish, the lower the penalty value. When a single field is not dichotomous but multi-classified, the form of the Loss function remains unchanged, and only aₖ is defined as aₖ t, which represents the inverse ratio of the i-th positive sample statistic value of the k-th field to the maximum class statistic value of the k-th field.

Finally, the automobile insurance element extraction module performs an effect test on the test set, compares the extracted results with the annotation results, and uses the consistency percentage as a model accuracy and effectiveness indicator. When the test accuracy is higher than 85%, the model can be considered valid. Otherwise, it is necessary to add annotation data or further adjust model parameters to optimize the model.

The process of automobile damage location element extraction for image is specifically as follows: the embodiment of the present invention extracts corresponding elements from automobile damage images through a target detection algorithm (Yolov5). Firstly, using the Yolov5 model trained by an open database COCO as the initial model, the initial YOLO model is trained in the annotated training set for model refinement. Specifically, the convolutional layer model for the first 80 layers remains unchanged, and the parameters after the 80 layers are randomly initialized and trained. Setting the threshold value of multiple penalty function drops as the training end flag, for example, if the penalty function drops below 20% within 5 rounds, the training ends. Then, using the trained model, the recognition of automobile components is realized. Then, the automobile damage location and the nearest automobile component are selected to roughly determine the automobile damage location. For example, image algorithm is used to learn the damage and characteristic parts of a car, such as headlights, rear lights, front bumpers, and doors, determining the automobile damage location and abstracting it into the structural data.

Finally, the automobile damage frame area is standardized, that is, decoupling the correlation between the number of pixels surrounding the automobile damage with the camera angle and the distance between the camera and the vehicle. The normalized automobile damage area is expressed as: otal pixels of the bounding-box/reference unit area, where the reference object is the license plate or wheel. Using the wheel as the side photo reference and the license plate as the front photo reference. According to the actual size of the wheel and license plate, calculating the actual area value per pixel, i.e. *cm²/pixel. Because the size of the license plate and the automobile are relatively fixed, for example, the size of the car hub is 15-19 inches, and the size of the blue plate is 440*140 mm. The area after standardization and metric area approximates a fixed proportion relationship.

The process of personnel identity information extraction is as follows: the Yolov5 method is used for face detection in the embodiment of the present invention. In the embodiment of the invention, the public face detection database is directly used as the training set, or the Yolov5 face detection pretrained model is downloaded for direct use in face detection. The personnel include drivers and surveyors from both sides of the accident. After detecting a face, an anti-fraud system is used for personnel recognition, and consistency judgment is performed against images stored in the database. The face detection model is pre trained on databases such as LFW.

S5: Inputting the automobile accident scene images into the trained model to extract automobile insurance, automobile damage, and personnel identity elements, laying a foundation for subsequent anti-fraud judgments. The automobile insurance anti-fraud system serves as an auxiliary decision-making system to filter cases with low fraud probability for automobile insurance investigators. When a case is judged as suspected fraud by the anti-fraud system, the automobile insurance investigators need to conduct a compliance review of the case elements to ultimately determine whether the case is suspected of fraud.

### Embodiment 1

Embodiment 1 of the present invention takes an automobile accident scene image as an example, based on the automobile insurance image element extraction table, performing image sampling, image annotation, training a model, and using the model to extract automobile insurance elements, automobile damage elements, and personnel identity information.

First of all, constructing the automobile insurance image element extraction table, extracting image element features with high accuracy and anti-fraud importance, based on the experience of automobile insurance anti-fraud experts and research experience in image processing algorithms. For this reason, the image element table constructed by the embodiment of the present invention only contains features based on image classification and target detection algorithm, and the corresponding model is an architecture used separately and in combination by Efficientnet and Yolov5, these two models meet the standards of the embodiment of the present invention that require relatively low computational power.

The described image sampling uses fine-grained automobile data as a training set, which is the comprehensive automobile database of the Chinese University of Hong Kong http://mmlab.ie.cuhk.edu.hk/datasets/comp_cars/index.html. On the basis of this database, image data is manually merged into various cars, SUVs, pickup trucks, buses, and engineering automobiles, etc. After data consolidation, the main differences between automobile categories are automobile contour, volume, and shape of the front and rear of the automobile. Then, Efficient net is used for classification training. Next, the trained model is used as an image vectorization encoder to vectorize the samples to be annotated. Finally, the farthest point method is used to sample vectorized samples, and the final set of images to be annotated is obtained by setting the number of samples. In effect, sampling reduces the number of samples and increases the proportion of sample diversity.

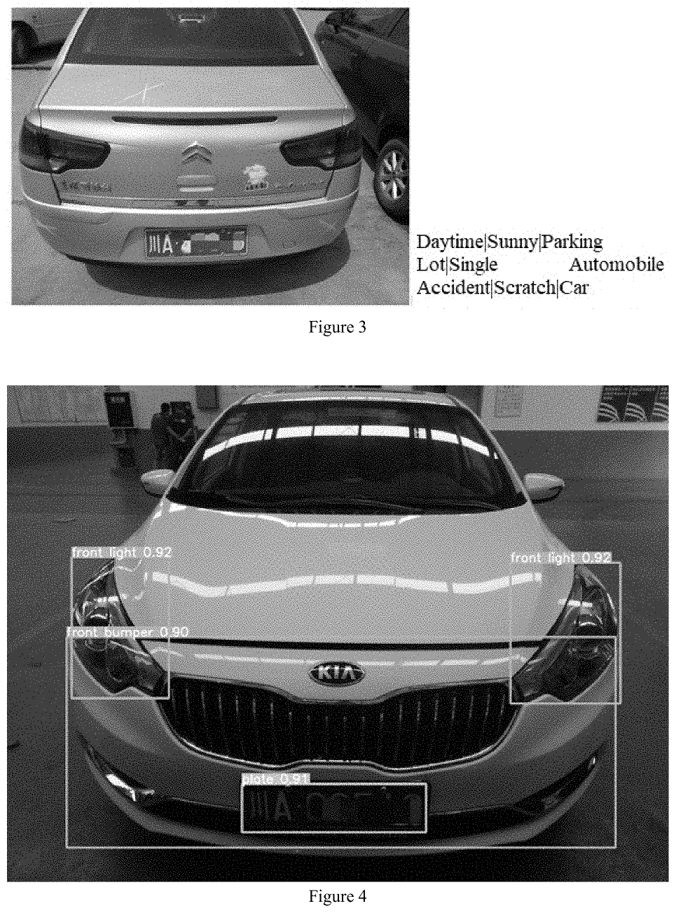

As shown in FIG. 3, FIG. 3 is the automobile accident scene images, the image is annotated with automobile insurance elements. For example, the image is annotated as: Daytime|Sunny|Parking Lot|Single Automobile Accident|Scratch|Car. The image annotation is completed in a annotation client, the annotation client is typically a program installed on a single computer. The computer also stores a training image set, an element configuration file, and so on. Where the element configuration file stores the task and feature name, for example:

{Automobile insurance element extraction task:

```
  Accident types: scratching, crushing, collision, combustion,
  water immersion, tire blowout,
sliding, overturning;
  Time: day, night;
  Automobile number: single automobile, double automobile,
  three automobiles, multiple
automobiles;
  ...
  }
  {Automobile damage element extraction task:
  Type of automobile damage: dents, scratches, combustion,
  glass breakage, tire blowout,
tears, falls off, bumps and bends;
  Automobile components: front right lamp, front left lamp,
  front bumper, front cover;
  }
```

The label annotation, first selecting the automobile insurance element task configuration file and image folder. After that, the client program automatically traverses the image file and displays it in the display box, at the same time, for multiple tasks such as accident type and time, the automobile insurance element name is displayed in a check box manner. The announcer clicks on the relevant automobile insurance element type based on experience to complete the annotation. The annotation results are recorded in a format such as txt, with the same name as the image, and saved in the automobile insurance element label folder.

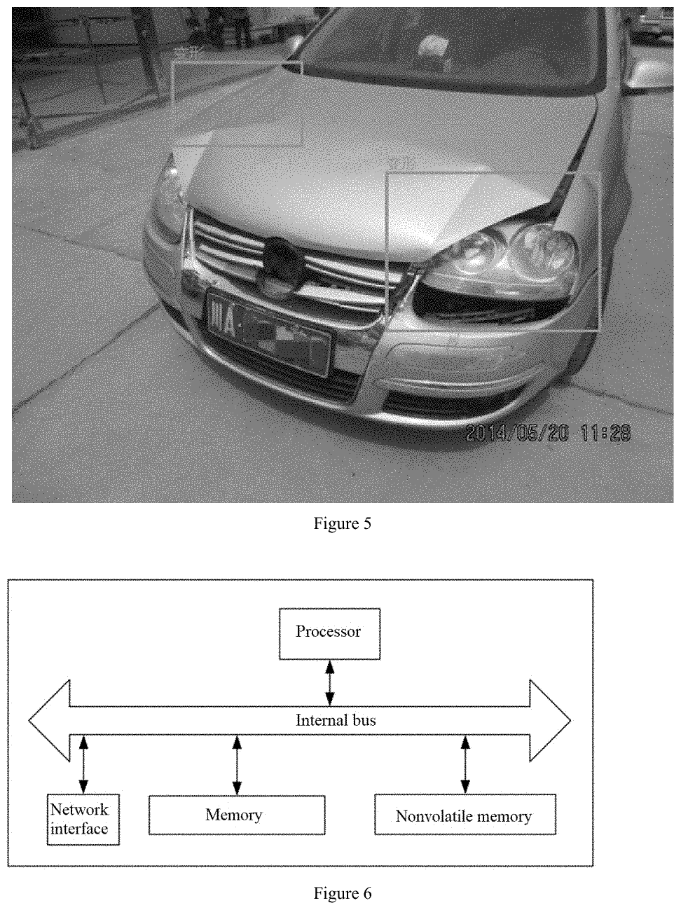

As shown in FIG. 4 and FIG. 5, for the automobile damage element annotation, first selecting the automobile damage element task configuration file and image folder. After that, the client program reads the image and displays it in the display box, at the same time, for tasks such as automobile damage types and automobile components, the name of the automobile damage element is displayed in a single selection box. The announcer frames the position of the target object in the form of [target center point x, target center point y, target width w, target height h], and then selects the automobile damage type in the selection area to complete the annotation. The annotation results are recorded in a format such as txt and stored in the automobile damage label folder.

The personnel element annotation is similar to the above automobile damage element, but only needs to frame the personnel without classification selection. The annotation results are in a format such as txt and stored in the personnel label folder.

There are many methods for image classification, with the main differences in model architecture and classification methods. Model architectures such as Resnet, Perceptionnet, VGGNet, MobileNet, Efficientnet, etc., the classification methods include multi class classification, multi task classification, and multi label classification. For the task of extracting automobile insurance elements, the embodiment of the present invention selects a multi-label classification method based on the Efficient net pretrained model, its advantages are that only one model is needed, and the model has fewer parameters, which converges quickly, the disadvantage is that there is a lack of type. Therefore, the present invention proposes a method for improving the penalty function to solve the problem of type missing in prediction. The Efficientnet performs pre training in the ImageNet database, and then performs fine tuning training using our annotation automobile insurance element dataset. During fine tuning training, the full connection layer at the end of the pre trained Efficientnet model is reset to a random weight value, and then the overall weight of the model is updated using an improved penalty function in a gradient descent manner. The method of pre training and fine tuning can significantly reduce training time. At the same time, due to the small weight changes at the bottom of the model, the model has certain generalization and differentiation capabilities for both positive samples that do not appear in the new annotation classification and negative samples of the new annotation classification, thereby ensuring model accuracy.

There are also many studies on target detection issues, including FastRCNN, SSD, Yolo, MaskCNN, etc, and image databases, including VOC2007. For the automobile damage element extraction task, this embodiment uses Yolov5 as a model, uses a pretrained model based on COCO training set, and performs fine tuning on this basis. The COCO training set is a relatively large set of target detection images, including about 300000 images, and manually annotates 80 types of objects. The Yolo model trained on this basis can extract more discriminative texture and contour features from images. For our newly annotation automobile damage element image, when fine-tuning the Yolo model, it is necessary to reset the full connection layer at the highest level of Yolo, and then using the penalty function of Yolo fusion location, confidence, and classification to iteratively update the model weight.

After training the extraction model, using the model to extract elements. The automobile insurance elements extraction is completed on a user client, which can be a separate mobile app, one or several functional modules embedded in the automobile insurance app of an automobile insurance company, or a single computer program on the server side.

When element extraction occurs at the user's mobile terminal, the mobile terminal has a shooting function and has completed automobile insurance image acquisition. The mobile terminal APP loads an extraction model to extract automobile insurance elements from the image, and displays the extraction results. The user performs image re acquisition based on the feedback results or transmits the extracted information back to the database server of the automobile insurance company. Users can be drivers or surveyors, surveyors are technical personnel related to automobile damage assessment, familiar with automobile insurance elements, and can review or modify the extracted element results based on experience. Finally, integrating the structured data of relevant automobiles that have been entered by the automobile insurance company in the early stage with the currently extracted automobile insurance elements, and conducting fraud prediction through the anti-fraud system.

When element extraction occurs on the server side, the mobile client needs to complete image acquisition and image transmission, the server loads the model and performs calculations, and then feeds back the extraction results to the user. The user performs image re acquisition based on the feedback results or approves that the extraction results are consistent with the current vehicle insurance scene. Finally, the extraction server submits the results to the data server of the automobile insurance company.

The feature extraction client can also have a communication module that can communicate with a remote server to achieve data transmission with the server. The server may include an insurance company anti-fraud system or an intermediate platform server. The specific architecture of the server can include a single computer device, a server cluster composed of multiple servers, servers in a distributed system, or servers combined with a blockchain.

The calculation of standardized automobile damage area is as follows: in order to convert the pixel area into the actual area, the method of total frame pixels/unit pixel millimeters square is used, where, the side reference is the wheel, the front reference is the license plate. Because the size of the license plate and the automobile are relatively fixed, for example, the size of the car hub is 15-19 inches, the average wheel size is 17 inches, and the diameter is 432.0 mm, and the height of the blue plate in the license plate is 140 mm. Therefore, the unit pixel corresponds to millimeter is 140/license plate height or 432/wheel height. The area after standardization and metric area approximates a fixed proportion relationship.

The specific methods for extracting personnel identity information are as follows: the face detection algorithm is a general method with many achievements and a public image library. This embodiment directly uses the COCO pre training Yolo model with its own face detection function. It should be noted that the degree and distance of the face have a significant impact on personnel recognition, so there are usually strict requirements when collecting faces. For example, using the interactive frame method to collect forward unobstructed faces.

In correspondence with the aforementioned embodiments of the method of image annotation and element extraction methods for automobile insurance anti-fraud, the present invention also provides embodiments of device of image annotation and element extraction methods for automobile insurance anti-fraud.

Referring to FIG. 6, the embodiment of the present invention provides a device of image annotation and element extraction for automobile insurance anti-fraud, comprising one or more processors, for implementing the method of image annotation and element extraction for automobile insurance anti-fraud.

The embodiment of the image annotation and element extraction device for automobile insurance anti-fraud of the present invention can be applied to any device with data processing capabilities, which can be a device or device such as a computer. Device embodiments can be implemented through software, or through hardware or a combination of software and hardware. Taking software implementation as an example, as a logical device, it is formed by reading corresponding computer program instructions from nonvolatile memory into memory and running them through the processor of any device with data processing capabilities in which it resides. From a hardware perspective, as shown in FIG. 6, it is a hardware structure diagram of any device with data processing capabilities where the image annotation and element extraction device for automobile insurance and anti-fraud of the present invention is located, in addition to the processor, memory, network interface, and nonvolatile memory shown in FIG. 6, In the embodiment, any device with data processing capabilities located in the device can also include other hardware based on the actual functions of the device with data processing capabilities, which will not be described again.

The implementation process of the functions of each unit in the above device is detailed in the implementation process of the corresponding steps in the above method, and will not be described again here.

For device embodiments, since they basically correspond to the method embodiments, it is sufficient to refer to the partial description of method embodiments for relevant aspects. The device embodiments described above are only illustrative, in which the units described as separate components can be or may not be physically separated, and the components displayed as units can be or may not be physical units, that is, they can be located in one place, or they can be distributed across multiple network units. Some or all of the modules can be selected according to actual needs to achieve the purpose of the solution of the present invention. Those skilled in the art can understand and implement it without paying creative labor.

The embodiment of the present invention also provides a computer-readable storage medium on which a program is stored, when the program is executed by the processor, the method of image annotation and element extraction for automobile insurance and anti-fraud in the above embodiment is implemented.

The computer-readable storage medium may be an internal storage unit, such as a hard disk or memory, of any device having data processing capabilities described in any of the preceding embodiments. The computer-readable storage medium can also be any device with data processing capabilities, such as a plug-in hard disk, Smart Media Card (SMC), SD card, Flash Card, and the like provided on the device. Further, the computer-readable storage medium may include both an internal storage unit of any device with data processing capabilities and an external storage device. The computer-readable storage medium is used to store the computer program and other programs and data required by any device with data processing capabilities, and can also be used to temporarily store data that has been or will be output.

The above embodiments are only used to illustrate the design idea and characteristics of the present invention, and their purpose is to enable those skilled in the art to understand the content of the invention and implement it accordingly. The scope of protection of the invention is not limited to the above embodiments. Therefore, any equivalent changes or modifications made based on the principles and design ideas disclosed in the present invention are within the scope of protection of the present invention.

1. A method of image annotation and element extraction for automobile insurance anti-fraud, comprising the following steps:
S1: based on fraud type, extracting automobile insurance elements to construct an automobile insurance element table by setting a judgment basis; wherein the steps S1 is as follows: analyzing automobile insurance anti-fraud cases, summarizing the judgment basis for fraud types such as fake accident scene, repeated claims, fake personnel identity, and secondary collision, obtaining anti-fraud rules based on image elements, and constructing the automobile insurance element table; the automobile insurance elements comprises automobile damage area, automobile damage location, accident time, weather, accident type, automobile damage degree, and personnel identity information;
S2: collecting an automobile accident scene image, and removing similar samples based on an image similarity measurement model through image vectorization and setting similarity threshold;
S3: based on the automobile insurance element table, annotating the automobile insurance features, automobile damage features, and personnel identity features respectively in the automobile accident scene images, and obtaining the annotated datasets of the automobile insurance elements, automobile damage elements, and personnel identity elements; wherein the steps S3 is as follows: based on the automobile insurance element table, annotating the automobile insurance element including automobile number, driving status, accident type, both sides, weather, time, and road conditions, annotating the automobile damage element including dent, bump, bend, scratches, combustion, glass breakage, tire blowout, tear, and fall, and annotating personnel identity information, and obtaining the annotated datasets of the automobile insurance elements, automobile damage elements, and personnel identity elements; and
S4: extracting automobile insurance elements based on weighted multi-label for the automobile insurance element annotation dataset, extracting automobile damage elements based on target detection algorithms for the automobile damage element annotation dataset, and extracting the personnel identity information based on face detection algorithms for the personnel identity annotation dataset.

2. (canceled)

3. The method of image annotation and element extraction for automobile insurance anti-fraud according to claim 1, wherein, the process of removing similar samples through image vectorization and setting similarity threshold of the steps S2 is as follows: using a fine-grained automobile classification database as a training set for the image similarity measurement model, the trained model is used as an image vectorization encoder; then, the distance between images is calculated using the image vectors and the farthest point sampling is performed; the distance of the sample is maximized by setting the sampling number or image similarity threshold to meet the diversity of the sampled automobile accident scene images.

4. (canceled)

5. The method of image annotation and element extraction for automobile insurance anti-fraud according to claim 1, wherein, the process of extracting automobile insurance elements based on weighted multi-label for the automobile insurance element annotation dataset is as follows: based on the Efficient net pretrained model based on Imagenet image dataset, the automobile insurance element annotation dataset is used as a training set to fine-tune the multi-label classification task based on weighted multi-label to obtain automobile insurance elements extracting model.

6. The method of image annotation and element extraction for automobile insurance anti-fraud according to claim 1, wherein, the process of extracting automobile damage elements based on target detection algorithms for the automobile damage element annotation dataset is as follows: based on the Yolo pretrained model based on the COCO imagedataset, the automobile damage element annotation dataset is used as a training set, the multi-label classification task is finetuned on the automobile damage image training set to obtain the automobile damage elements extracting model, then the actual automobile damage area is calculated by standardizing the automobile damage pixel area.

7. The method of image annotation and element extraction for automobile insurance anti-fraud according to claim 6, wherein, the process of standardizing the automobile damage pixel area is as follows: decoupling the correlation between the number of pixels surrounding the automobile damage with the camera angle and the distance between the camera and the vehicle, using the wheel as the side photo reference and the license plate as the front photo reference, calculating the ratio between the total pixels of the bounding-box and the actual size per pixel obtain a normalized automobile damage area; according to the actual size of the wheel and license plate, calculating the actual area per pixel.

8. A system of image annotation and element extraction for automobile insurance anti-fraud, which is applied to the method of image annotation and element extraction for automobile insurance anti-fraud according to claim 1, wherein, comprising an automobile insurance element table construction module, an image acquisition module, an annotation module and an element extraction module;
the automobile insurance element table construction module, based on fraud type, extracting automobile insurance elements to construct an automobile insurance element table by setting a judgment basis;
the image acquisition module, collecting images to be annotated, the images are derived from automobile accident scene images collected by insurance companies, automobile damage image sets published online, and images collected through road monitoring cameras; the collected images also need to undergo previous preprocessing including deduplication and desimilarity;
the annotation module, based on the automobile insurance element table, annotating the automobile insurance features, automobile damage features, and personnel identity features respectively in the images to be annotated, and obtaining an automobile insurance element annotation dataset, an automobile damage element annotation dataset, and a personnel identity annotation dataset;
the element extraction module, extracting elements from the automobile insurance element annotation dataset, the automobile damage element annotation dataset, and the personnel identity annotation dataset.

9. An electronic device, comprising a memory and a processor, wherein, the memory is coupled to the processor; the memory is used to store program data, and the processor is used to execute the program data to implement the method of image annotation and element extraction for automobile insurance anti-fraud in claim 1.

10. A computer-readable storage medium on which a computer program is stored, wherein, the program is executed by a processor to implement the method of image annotation and element extraction for automobile insurance anti-fraud in claim 1.
